(19) United States
(12) Patent Application Publication
(10) Pub. No.: US 2008/0120679 A1
(43) Pub. Date: May 22, 2008

(54) BROADCASTING SIGNAL RECEIVING APPARATUS AND CONTROL METHOD THEREOF

(75) Inventor: Ah-young LIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/771,208

(22) Filed: Jun. 29, 2007

(30) Foreign Application Priority Data
Nov. 21, 2006 (KR) 10-2006-0115511

(51) Int. Cl. H04N 7/173

(52) U.S. Cl. 725/134

(57) ABSTRACT

A broadcasting signal receiving apparatus including a broadcasting signal tuning unit which receives a broadcasting signal; an input unit which receives a channel changing command; a memory which saves information regarding a representative channel corresponding to a major channel; and a controller which searches selectable channels corresponding to the major channel if the major channel is selected through the channel changing command received by the input unit, determines whether the representative channel is included in the searched selectable channels and controls the broadcasting signal tuning unit to change a current channel to the determined representative channel.

### CROSS-REFERENCE TO RELATED APPLICATIONS

This application claims priority from Korean Patent Application No. 10-2006-0115511, filed on Nov. 21, 2006 in the Korean Intellectual Property Office, the disclosure of which is incorporated herein by reference.

### BACKGROUND OF INVENTION

1. Field of Invention

Apparatuses and methods consistent with the present invention relate to broadcasting signal reception and control, and more particularly, automatically changing a channel to a representative channel according to a setting by a user.

2. Description of the Related Art

Recently, digital broadcasting has become widely used so that a data service, as well as a video service and an audio service, can be received through a television.

Digital broadcasting is capable of having a plurality of channels in one physical channel differently from an analog broadcasting. In other words, digital broadcasting is capable of transmitting data compressed from large amounts of data in the physical channel so that a plurality of channels comprised in one physical channel can be transmitted.

Accordingly, analog broadcasting maps only one channel to one channel number such as 7, 11 or 13. However, digital broadcasting sets a channel number based on the concept of a major channel and a minor channel by using a virtual channel, which is different from the physical channel. Specifically, digital broadcasting indicates a channel in a collective number having major channel number and a minor channel number, such as 7-0, 7-2 or 7-4. Accordingly, the number of the tunable channels gets too large if a predetermined major channel number is input, because digital broadcasting may comprise a plurality of minor channels having the same major channel number.

There are some related art methods which select a channel in a digital television. First, if a user selects a predetermined major channel number, one of the plurality of minor channels corresponding to the major channel is selected according to a method set in the digital television. Second, if a number key is input by a remote controller, a tunable channel list is displayed as an On Screen Display (OSD) so that the user can select the desired channel.

However, the first method may make the user uncomfortable because the intention of the user is not reflected, and the second method may make the user uncomfortable because the user is additionally required to input one or more keys on the remote controller.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

The present invention provides a broadcasting signal receiving apparatus and control method thereof in which a representative channel of each major channel is assigned and the assigned representative channel is displayed if a channel is changed, thus providing convenience to a user.

Additional aspects of the present invention will be set forth in part in the description which follows and, in part, will be apparent from the description, or may be learned by practice of the present invention.

According to an aspect of the present invention, there is provided a broadcasting signal receiving apparatus comprising: a broadcasting signal tuning unit which receives a broadcasting signal; a user input unit which receives a channel changing command by a user; a memory which saves information regarding a representative channel corresponding to a major channel; and a controller which searches a selectable channel corresponding to the major channel if the major channel is selected through the channel changing command received by the user input unit, determines whether the representative channel is included in the searched channels and controls the broadcasting signal tuning unit to change a current channel to the determined representative channel.

The controller may control the broadcasting signal tuning unit to change the current channel to a predetermined channel of the searched channels if the representative channel is not included in the searched channels.

The broadcasting signal receiving apparatus may further comprise a user interface (UI) generator which generates a user setting menu to set the representative channel corresponding to the major channel, wherein the controller controls the UI generator to generate the user setting menu according to a menu command from the user input unit and saves information regarding the representative channel input from the user input unit in the memory.

According to another aspect of the present invention, there is provided a broadcasting signal receiving apparatus comprising: a broadcasting signal tuning unit which receives a broadcasting signal; a user input unit which receives a channel changing command by a user; a memory which saves information regarding a representative channel corresponding to a major channel; and a controller which determines the representative channel corresponding to the selected major channel in the memory if the major channel is selected through the channel changing command received by the user input unit and controls the broadcasting signal tuning unit to change a current channel to the determined representative channel.

According to another aspect of the present invention, there is provided a broadcasting signal receiving apparatus comprising: a broadcasting signal tuning unit which receives a broadcasting signal; a user input unit which receives a channel changing command by a user; a memory which saves information regarding a representative channel corresponding to a major channel; a channel searching unit which searches a selectable channel corresponding to a major channel in a predetermined channel list if the major channel is selected through the channel changing command received by the user input unit; a representative channel determining unit which determines whether the representative channel saved in the memory is one of the searched channels; and a channel changing unit which controls the broadcasting signal tuning unit to change a current channel to the determined representative channel if the representative channel is one of the searched channels and change the current channel to the one of the searched channels if the representative channel is not one of the searched channels according to a result of determination.

The selectable channel corresponding to the major channel may be a minor channel comprised in the major channel.

According to another aspect of the present invention, there is provided a control method of a broadcasting signal receiving apparatus, comprising: receiving a selection of a representative channel corresponding to a respective major channel by a user; saving information regarding the selected representative channel in a memory; searching a selectable channel corresponding to the major channel in a predetermined channel list if the user selects the major channel; determining whether the representative channel saved in the memory is one of the searched channels; and changing a current channel to the determined representative channel if the representative channel is one of the searched channels and changing the current channel to a predetermined one of the searched channels if the determined representative channel is not one of the searched channels.

According to another aspect of the present invention, there is provided a control method of a broadcasting signal receiving apparatus, comprising: receiving a selection of a representative channel corresponding to a respective major channel by a user; saving information regarding the selected representative channel in a memory; searching a selectable channel corresponding to the major channel in a predetermined channel list if the user selects the major channel; determining whether the representative channel saved in the memory is one of the searched channels; and changing a current channel to the determined representative channel.

According to another aspect of the present invention, there is provided a control method of a broadcasting signal receiving apparatus, comprising: receiving a selection of a representative channel corresponding to a respective major channel by a user; saving information regarding the selected representative channel in a memory; determining the representative channel which is saved in the memory and corresponds to the major channel if the user selects the major channel; and changing a current channel to the determined representative channel.

The selectable channel corresponding to the major channel may be a minor channel comprised in the major channel.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a control block diagram of a digital television according to an exemplary embodiment of the present invention;

FIGS. 2 and 3 are flowcharts of a method to set a representative channel according to an exemplary embodiment of the present invention;

FIG. 4 is a schematic view of a digital television according to an exemplary embodiment of the present invention; and

FIG. 5 is a control flowchart of a digital television according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout the disclosure. The exemplary embodiments are described below, and explain the present invention by referring to the figures.

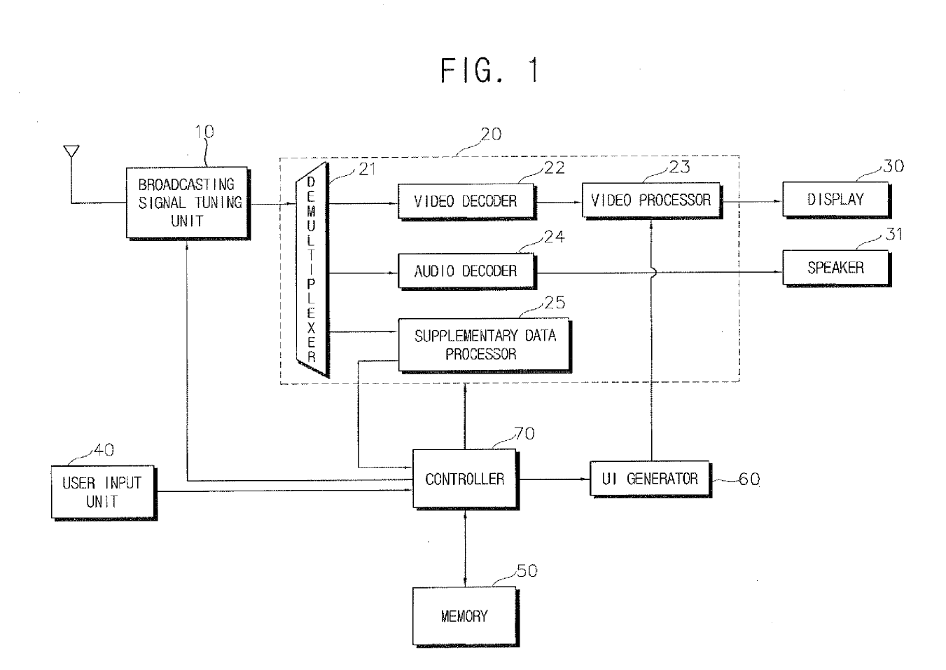

As shown in FIG. 1, a digital television according to an exemplary embodiment of the present invention comprises a broadcasting signal tuning unit 10, a signal processor 20, a display 30, a speaker 31, a user input unit 40, a memory 50, a UI generator 60 and a controller 70.

The broadcasting signal tuning unit 10 tunes a channel frequency to receive a broadcasting signal of the corresponding channel according to controlling of the controller 70 to be described later, and comprises a channel detection module (not shown) and a Radio Frequency (RF) demodulation module (not shown).

The broadcasting signal demodulated in the broadcasting signal tuning unit 10 is processed in the signal processor 20 and is output to the display 30 and the speaker 31. Herein, the signal processor 20 may comprise a demultiplexer 21, a video decoder 22, a video processor 23, an audio decoder 24 and a supplementary data processor 25.

The demultiplexer 21 divides the demodulated broadcasting signal into a video signal, an audio signal and a supplementary data.

The video signal, the audio signal and the supplementary data, which are divided in the demultiplexer 21, are respectively decoded in the video decoder 22, the audio decoder 24 and the supplementary data processor 25. Herein, the video decoder 22, the audio decoder 24 and the supplementary data processor 25, respectively, decode the signals to decoding formats corresponding to encoding formats of the broadcasting signal being transmitted. The decoded video signal is processed to correspond to a vertical frequency, a resolution and an aspect ratio of a screen which are suitable for an output standard of the display 30 by the video processor 23. In addition, a video processing module such as a scaler may be comprised in the video processor 23.

The decoded audio signal is output to the speaker 31.

The display 30 comprises a display panel (not shown) which displays an image and a panel driving unit (not shown) which controls driving of the display panel. The display 30 according to an exemplary embodiment of the present invention includes various types of display modules such as a Digital Light Processing (DLP) device, a Liquid Crystal Display (LCD), and a Plasma Display Panel (PDP).

A user input unit 40 is provided to select or input various functions of the digital television by the user such as selecting the channel and selecting or operating a UI menu. In addition, the user input unit 40 comprises a key (not shown) or a button (not shown), and a key signal generator (not shown) which generates a key signal corresponding to operation of the key or the button. The user input unit 40 may comprise a remote controller, a mouse, a keyboard, a keypad, a touch panel or a unit provided for a case of a digital television main body.

The memory 50 saves information regarding a representative channel corresponding to each major channel set by the user, and may comprise an Electrically Erasable and Programmable Read Only Memory (EEPROM) and other known memories in the art.

The UI generator 60 generates a user setting menu to set the representative channel corresponding to the respective major channel, and comprises an On Screen Display Integrated Circuit (OSD IC) which processes a UI menu data generated by a predetermined algorithm. The UI menu generated by the UI generator 60 is mixed with the current broadcasting signal by the scaler of the video processor 23 and the mixed UI menu and the current broadcasting signal is displayed on the display 30.

The controller 70 controls the digital television generally. Specifically, the controller 70 controls the digital television to be turned to a channel according to representative channel information set by the user during a process of channel selection and to generate and operate the UI menu. The controller 70 may be embodied by a Micro Controller Unit (MCU) which saves a corresponding algorithm code to control the digital television and executes the saved algorithm code.

The controller 70 determines the representative channel corresponding to the selected major channel in the memory 50 if a channel changing command is received through the user input unit 40 and controls the broadcasting signal tuning unit 10 to change a current channel to the determined representative channel. Accordingly, the channel can be changed to the representative channel which is previously set by the user among the plurality of channels and corresponds to the selected major channel.

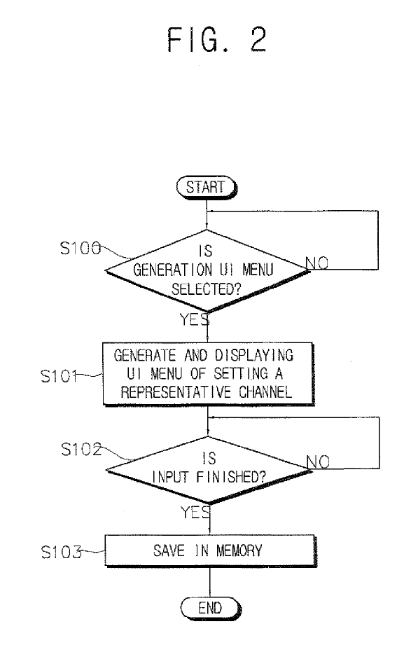

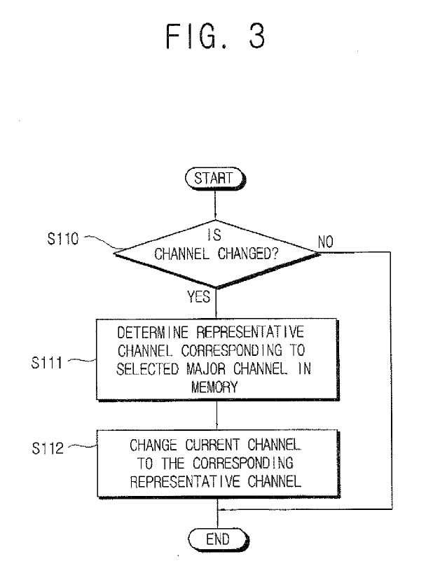

Hereinafter, methods to select the representative channel and change the channel are described by referring to FIGS. 2 and 3.

The controller 70 controls the UI generator 60 to generate the UI menu through which the user sets the representative channel at operation S101 if a function to display the UI menu is selected through the user input unit 40 at operation S100.

The user operates the user input unit 40 to input and/or select the representative channel in a representative channel input item corresponding to the respective major channel on the UI menu at operation S102. Then, the information regarding the representative channel input and/or selected by the user is saved in the memory 50 by the controller 70 at operation S103.

After that, if the channel changing command is input by the user at operation S110, the controller 70 determines the representative channel corresponding to the selected major channel in the memory 50 at operation S111. Next, the controller 70 controls the broadcasting signal tuning unit 10 to change the current channel into the determined representative channel at operation S112.

For example, if the user selects 11-4 as the representative channel with respect to the major channel 11 and selects 7-5 as the representative channel with respect to the major channel 7, the controller 70 saves the information regarding the selected representative channel in the memory 50. Later, if the user selects 11, the controller 70 controls the broadcasting signal tuning unit 10 to change the current channel to 11-4 by referring to the representative channel information saved in the memory 50.

Accordingly, if the user selects the major channel, the user may watch the representative channel which the user assigned in advance for the selected major channel.

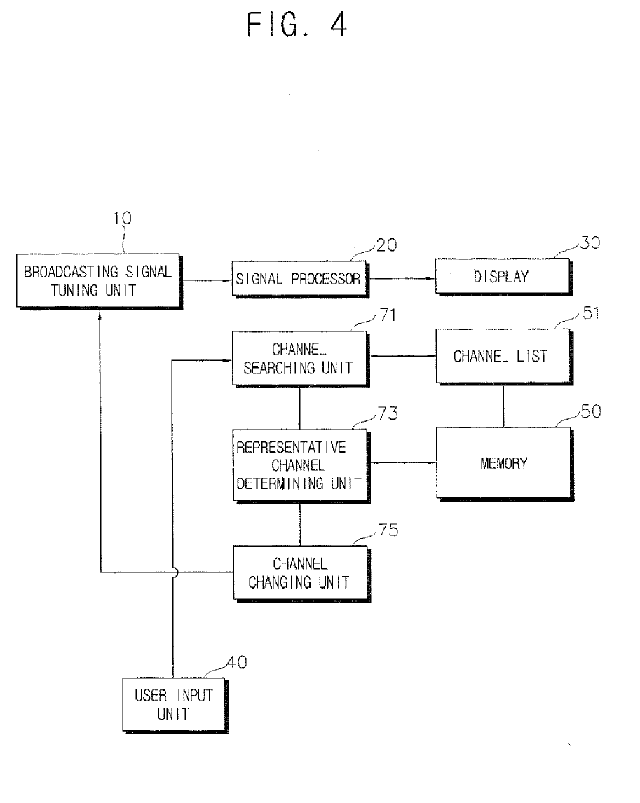

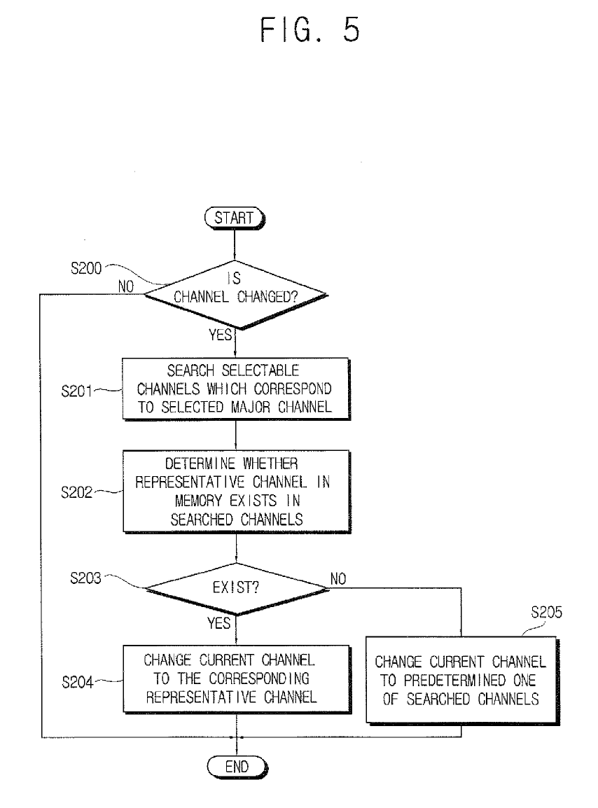

FIG. 4 and FIG. 5 illustrate a schematic diagram and a control flowchart of the digital television, respectively, according to a an exemplary embodiment of the present invention.

As shown in FIG. 4, a digital television according to a second exemplary embodiment of the present invention comprises a broadcasting signal tuning unit 10, a signal processor 20, a display 30, a user input unit 40, a memory 50, a channel list 51, a channel searching unit 71, a representative channel determining unit 73 and a channel changing unit 75. Hereinafter, exemplary embodiments will be described in detail with reference to the accompanying drawings. Identical or corresponding elements will be given the same reference numerals, regardless of the figure number, and any redundant description of the identical or corresponding elements will not be repeated.

The channel list 51 comprises information regarding a channel which is capable of being tuned. Specifically, the channel list 51 comprises information regarding the channel including a current broadcasting signal which is searched in a predetermined channel frequency if power is turned on or the channel searching command is input by the user. The channel list 51 is provided as follows. The broadcasting signal tuning unit 10 tunes the corresponding channel sequentially by using information regarding a middle frequency corresponding to each channel which is previously saved, then each channel is determined whether the broadcasting signal is received by tuning of the broadcasting signal tuning unit 10. Here, the channel may be searched by an algorithm stored in a Micro Controller Unit (MCU).

The channel searching unit 71 searches the tunable channels or selectable channels corresponding to the selected major channel in the channel list 51 at operation S201 if the channel changing command is input by the user at operation S200.

Next, the representative channel determining unit 73 compares the searched tunable channels with the representative channel set in the memory 50 and determines whether the representative channel is comprised in the searched tunable channels at operation S202.

If the representative channel is comprised in the tunable channels at operation S203, the channel changing unit 75 controls the broadcasting signal tuning unit 10 to change the current channel into the corresponding representative channel at operation S204. If the representative channel is not comprised in the tunable channels, the channel changing unit 75 controls the broadcasting signal tuning unit 10 to change the current channel to a predetermined channel among the tunable channels at operation S205.

The channel searching unit 71, the representative channel determining unit 73 and the channel changing unit 75 may be embodied by an algorithm and a processor executing the algorithm and the respective elements may be embodied by the algorithm which are executed in the MCU.

For example, if the user selects the major channel 11, the channel searching unit 71 searches one of the tunable channels corresponding to the major channel 11 in the channel list 51. Then, if the channels 11-0, 11-2 and 11-3 are searched as the tunable channels, the representative channel determining unit 73 determines the representative channel saved in the memory 50 and compares the representative channel with the searched channels.

As a result of the determination, if the representative channel corresponding to the major channel 11 is 11-3, the channel changing unit 75 controls the broadcasting signal tuning unit 10 to change the current channel into 11-3. If the representative channel corresponding to the major channel 11 is 11-4, the channel converting unit 75 controls the broadcasting signal tuning unit 10 to change the current channel into one of 11-0, 11-2 and 11-3. Here, the present invention may be preset to change the current channel to 11-0, a first number of the tunable channels.

In this way, the representative channel may be set by the user and the channel can be changed according to the set representative channel.

The digital television is described as an example in the above exemplary embodiments but the present invention can be applied to every broadcasting signal receiving apparatus which has a function of receiving the digital broadcasting signal.

As described above in the exemplary embodiments, the present invention changes the current channel into an assigned representative channel by assigning the representative channel to the respective major channel to provide the user with convenience.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting signal receiving apparatus comprising:
a broadcasting signal tuning unit which receives a broadcasting signal;
an input unit which receives a channel changing command;
a memory which saves information regarding a representative channel corresponding to a major channel; and
a controller which searches selectable channels corresponding to the major channel if the major channel is selected through the channel changing command received by the input unit, determines whether the representative channel is included in the searched selectable channels and controls the broadcasting signal tuning unit to change a current channel to the representative channel.

2. The broadcasting signal receiving apparatus according to claim 1, wherein the controller controls the broadcasting signal tuning unit to change the current channel to a channel of the searched selectable channels if the representative channel is not included in the searched selectable channels.

3. The broadcasting signal receiving apparatus according to claim 2, further comprising a user interface (UI) generator which generates a user setting menu to set the representative channel corresponding to the major channel, wherein the controller controls the UI generator to generate the user setting menu according to a menu command from the input unit and saves the representative channel input from the input unit in the memory.

4. The broadcasting signal receiving apparatus according to claim 1, further comprising a user interface (UI) generator which generates a user setting menu to set the representative channel corresponding to the major channel, wherein the controller controls the UI generator to generate the user setting menu according to a menu command from the input unit and saves the representative channel input from the input unit in the memory.

5. The broadcasting signal receiving apparatus according to claim 1, wherein each of the selectable channels is a minor channel comprised in the major channel.

6. A broadcasting signal receiving apparatus comprising:
a broadcasting signal tuning unit which receives a broadcasting signal;
an input unit which receives a channel changing command;
a memory which saves a representative channel corresponding to a major channel; and
a controller which determines the representative channel corresponding to the major channel in the memory if the major channel is selected through the channel changing command received by the input unit, and controls the broadcasting signal tuning unit to change a current channel to the determined representative channel.

7. The broadcasting signal receiving apparatus according to claim 6, wherein each of the selectable channels is a minor channel comprised in the major channel.

8. A broadcasting signal receiving apparatus comprising:
a broadcasting signal tuning unit which receives a broadcasting signal;
an input unit which receives a channel changing command;
a memory which saves a representative channel corresponding to a major channel;
a channel searching unit which searches selectable channels corresponding to a major channel in a channel list if the major channel is selected through the channel changing command received by the input unit;
a representative channel determining unit which determines whether the representative channel saved in the memory is one of the searched selectable channels; and
a channel changing unit which controls the broadcasting signal tuning unit to change a current channel to the determined representative channel if the representative channel is one of the searched selectable channels and change the current channel to the one of the searched selectable channels if the representative channel is not one of the searched selectable channels according to a result of determination.

9. The broadcasting signal receiving apparatus according to claim 8, wherein each of the selectable channels is a minor channel comprised in the major channel.

10. A control method of a broadcasting signal receiving apparatus, the control method comprising:
receiving a selection of a representative channel corresponding to a respective major channel;
saving the selected representative channel in a memory;
searching selectable channels corresponding to the major channel in a channel list if the major channel is selected;
determining whether the representative channel saved in the memory is one of the searched selectable channels; and
changing a current channel to the determined representative channel if the representative channel is one of the searched selectable channels and changing the current channel to a one of the searched selectable channels if the determined representative channel is not one of the searched selectable channels.

11. The control method of the broadcasting signal receiving apparatus according to claim 10, wherein each of the selectable channels is a minor channel comprised in the major channel.

12. A control method of a broadcasting signal receiving apparatus, the control method comprising:
receiving a selection of a representative channel corresponding to a respective major channel;
saving the selected representative channel in a memory;
searching selectable channels corresponding to the major channel in a channel list if the major channel is selected;
determining whether the representative channel saved in the memory is one of the searched selectable channels; and
changing a current channel to the determined representative channel.

13. The control method of the broadcasting signal receiving apparatus according to claim 12, wherein each of the selectable channels is a minor channel comprised in the major channel.

14. A control method of a broadcasting signal receiving apparatus, the control method comprising:
receiving a selection of a representative channel corresponding to a respective major channel;
saving the selected representative channel in a memory;
determining the representative channel which is saved in the memory and corresponds to the major channel if the major channel is selected; and
changing a current channel to the determined representative channel.

15. The control method of the broadcasting signal receiving apparatus according to claim 14, wherein each of the selectable channels is a minor channel comprised in the major channel.
